(19) United States
(12) Patent Application Publication
(10) Pub. No.: US 2008/0299421 A1
(43) Pub. Date: Dec. 4, 2008

(54) Method for Analyzing the Performance of Mea and Segmented Cell Used for the Method

(75) Inventors: Eun Ae Cho, Seoul (KR); In-Hwan Oh, Seoul (KR); Hyoung-Juhn Kim, Gyeonggi-do (KR); Yeong Cheon Kim, Seoul (KR); Sang-Yeop Lee, Seoul (KR); Tae-Hoon Lim, Seoul (KR); Suk-woo Nam, Seoul (KR); Sung Pil Yoon, Kyunggi-do (KR); Jonghee Han, Seoul (KR); Heung Yong Ha, Seoul (KR); Hyung Chul Hahm, Gangwon-do (KR); Jaeyoung Lee, Incheon (KR)

Correspondence Address: MERCHANT & GOULD PC, P.O. BOX 2903, MINNEAPOLIS, MN, 55402-0903, US

(73) Assignee: Korea Institute of Science & Technology, Seoul (KR)

(21) Appl. No.: 12/063,919

(22) PCT Filed: Oct. 31, 2005
(86) PCT No.: PCT/KR2005/003633

§ 371 Date: Aug. 19, 2008

(30) Foreign Application Priority Data
Aug. 18, 2005 (KR) 10-2005-0075831

(51) Int. Cl. H01M 8/00

(52) U.S. Cl. 429/13

(57) ABSTRACT

A separation plate having a gas flow path is segmented for analyzing MEA performance without segmenting an electrode or a gas diffusion layer. In advance, a MEA is operated for a long time in a real stack environment using a typical separation plate which is not segmented, and then the segmented separation plate for analyzing MEA performance is mounted to the MEA.

### TECHNICAL FIELD

The invention relates to a method for analyzing performance of MEA and a segmented cell used for the method. More specifically, the invention relates to a method for analyzing performance of MEA and a segmented cell used for the method wherein a separation plate having a gas flow path is segmented without segmenting an electrode or a gas diffusion layer so that a deformation of a unit cell structure can be minimized and as well a degradation can be carried out as like that in a real MEA stack, thereby analyzing performance and electrochemical characteristics in each part of the degraded MEA.

### BACKGROUND ART

In general, in a large area MEA, a current density adjacent to a gas inlet is higher than that adjacent to a gas outlet, which means that a performance decrease of the MEA is much more affected by an environment to which the MEA is exposed than by an amount of electrochemical reaction.

In order to carry out a performance analysis depending on parts of the MEA, a variety of cell designs for segmenting a unit cell at a predetermined position and measuring a change in performance while uniformly applying a current or voltage to the segmented position (so-called, a segmented cell) has been developed [S. J. C. Cleghorn, C. R. Derouin, M. S. Wilson, and S. Gottesfeld, J. of Appl. Electrochem., 28, 663 (1998); M. Noponen, T. Mennola, M. Mikkola, T. Hottinen, and P. Lund, J. of Power Sources, 106, 304 (2002); D. J. L. Brett, S. Atkins, N. P. Brandon, V. Vesovic, N. Vasileiadis, and A. R. Kucernak, Electrochem. Comm., 3, 628 (2001); Ch. Wiesser, A. Helmbold, and E. Gulzow, J. of Appl. Electrochem., 30, 803 (2000)].

For example, it was reported that an anode is segmented among the unit cell [S. J. C. Cleghorn, C. R. Derouin, M. S. Wilson, and S. Gottesfeld, J. of Appl. Electrochem., 28, 663 (1998)], and it was also reported that a cathod is segmented among the unit cell [M. Noponen, T. Mennola, M. Mikkola, T. Hottinen, and P. Lund, J. of Power Sources, 106, 304 (2002)].

Regarding this, Noponen, et al. has reported that while a gas sealing is difficult when segmenting the anode, segmenting the cathode and shaping it into an air intake form can prevent the performance decrease due to fuel loss [D. J. L. Brett, S. Atkins, N. P. Brandon, V. Vesovic, N. Vasileiadis, and A. R. Kucernak, Electrochem. Comm., 3, 628 (2001)].

In addition, a method of forming an air flow path to a PCB (printed circuit board), coating a segmented Au layer thereon to form a collector, welding an Au wire passing through the PCB to the collector and then adjusting and measuring current and voltage has been known [S. J. C. Cleghorn, C. R. Derouin, M. S. Wilson, and S. Gottesfeld, J. of Appl. Electrochem., 28, 663 (1998); M. Noponen, T. Mennola, M. Mikkola, T. Hottinen, and P. Lund, J. of Power Sources, 106, 304 (2002); D. J. L. Brett, S. Atkins, N. P. Brandon, V. Vesovic, N. Vasileiadis, and A. R. Kucernak, Electrochem. Comm., 3, 628 (2001)].

Further, a method of positioning a Hall sensor beneath an air flow path made of segmented Ti to measure inductive magnetic force, thereby calculating current has been used [Ch. Wiesser, A. Helmbold, and E. Gulzow, J. of Appl. Electrochem., 30, 803 (2000)].

However, among the methods of segmenting a unit cell for analyzing the MEA performance, the method of segmenting an electrode or air diffusion layer of the unit cell has a problem that the gas sealing is difficult and deformation also occurs in the unit cell structure.

Meanwhile, there has been a method of segmenting a separation plate having an air flow path and mounting it to a MEA to analyze the performance thereof. According to this method, the segmented separation plate is mounted to the MEA from the beginning and then the change in the performance is real-time measured while operating the MEA for a long time.

However, such method of mounting the segmented separation plate to the MEA from the beginning and then measuring the change in the performance while operating the MEA for a long time has a problem that a degradation can be differently occurred compared to the real situation since the environment is changed from that of the real stack.

### DISCLOSURE OF INVENTION

### Technical Problem

The invention is made to solve the above problems occurring in the art. An object of the invention is to provide a method for analyzing performance of MEA and a segmented cell used for the method wherein a separation plate having a gas flow path is segmented without segmenting an electrode or a gas diffusion layer so that a de-formation of a unit cell structure can be minimized and as well a degradation can be carried out as like that in a real MEA stack, thereby analyzing performance and electrochemical characteristics in each part of the degraded MEA.

### Technical Solution

In order to accomplish the above object, there is provided a method for analyzing performance of MEA, wherein a separation plate having a gas flow path is segmented and mounted to MEA for analyzing performance of MEA, the method comprising steps of: mounting a typical separation plate, which is not segmented, to a MEA and carrying out the operation of the MEA (S1); and mounting the separation plate, which is segmented for analyzing performance of MEA, to the MEA in which the operation is completed and carrying out the analysis of the performance of the MEA (S2). According to an embodiment of the invention, it is preferred that the gas flow path is formed in each of the segmented areas of the segmented separation plate used in the S2 step so that the gas can flow individually in each of the segmented areas of the segmented separation plate.

In order to accomplish the above object, there is provided a segmented cell for analyzing performance of MEA, comprising a separation plate having a gas flow path, the separation plate being segmented for analyzing performance of MEA and the gas flow path being formed in each of the segmented areas of the segmented separation plate so that the gas can flow individually in each of the segmented areas of the segmented separation plate.

According to an embodiment of the invention, it is preferred that the segmented cell is provided with a penetrating hole at a side of the segmented separation plate through which cooling water is able to be supplied.

### Advantageous Effects

According to the invention, by segmenting a separation plate having a gas flow path without segmenting an electrode or a gas diffusion layer, a deformation of a unit cell structure can be minimized. Further, according to the invention, a degradation can be carried out as like that in a real MEA stack, thereby analyzing performance and electrochemical characteristics in each part of the degraded MEA.

### BRIEF DESCRIPTION OF THE DRAWINGS

FIG. 1 is a schematic view showing a segmented separation plate for analyzing performance of MEA seen from a cathode, which plate is again mounted to a MEA wherein a long time operation is completed with a typical separation plate mounted thereto and is provided with individual flow paths.

FIG. 2 is a schematic view showing the segmented separation plate, wherein the individual flow paths formed, seen from an anode.

FIG. 3 is a graph showing i-V values of a MEA after a long time operation of 5,500 hours, which are measured using a segmented cell according to an example of the invention.

FIG. 4 is a graph showing voltage distributions at each measurement part of a MEA in case of 560 mA/cm² of a specific current density after a long time operation of 5,500 hours, which are measured using a segmented cell according to an example of the invention.

FIG. 5 is a Nyquist plot showing impedances of a MEA after a long time operation of 5,500 hours, which are measured using a segmented cell according to an example of the invention.

FIG. 6 is a graph showing ohmic resistances in each measurement part of a MEA after a long time operation of 5,500 hours, which are measured using a segmented cell according to an example of the invention.

FIG. 7 is a graph showing charge transfer resistances in each measurement part of a MEA after a long time operation of 5,500 hours, which are measured using a segmented cell according to an example of the invention.

FIG. 8 is a cyclic voltammogram showing a cyclic voltammetry of a MEA after a long time operation of 5,500 hours, which is measured using a segmented cell according to an example of the invention, and

FIG. 9 is a graph showing platinum catalyst utilization at a humidification cathode in each part of a MEA after a long time operation of 5,500 hours, which are measured using a segmented cell according to an example of the invention.

### MODE FOR THE INVENTION

Hereinafter, a method for analyzing performance of MEA and a segmented cell used for the method according to the invention is described in detail.

Contrary to a prior method of mounting a segmented separation plate to a MEA and measuring performance thereof while operating the MEA for a long time so as to analyze the MEA performance (so-called segmented cell operation method), according to the invention, a MEA is operated for a long time in a real stack environment using a typical separation plate which is not segmented (S1), and after completing the operation, again mounting a segmented separation plate for analyzing the MEA performance to the MEA in which degradation is made under the same environment as that of the real stack, and measuring performances (i-V) and electrochemical characteristics (impedance, cyclic voltammetry) in each part of the MEA (S2).

The segmented separation plate for analyzing the MEA performance, for example, consists of a support of insulating polymer such as polycarbonate, acryl and epoxy glass and segmented individual areas in which a conducting graphite block is inserted after a part of the support is cut and removed.

The segmented separation plate is provided with a gas flow path. Herein, although a gas flow path having one gas inlet and outlet can be formed throughout the whole segmented separation plate (continuous flow path), it is much preferred to individually form the gas flow path in each of the segmented areas of the separation plate, through which gas can flow individually. That is, if formed is the gas flow path allowing the gas to be introduced and discharged individually in each of the segmented areas (individual flow path), it is possible to correctly analyze difference of the degradation degrees between the individual areas. Such correct analysis is very suitable for the performance analysis of the MEA in which the degradation is made under real stack situation.

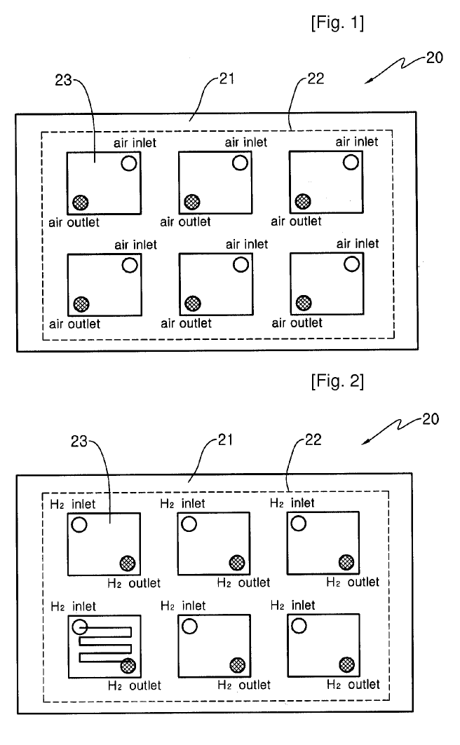

FIG. 1 is a schematic view showing a segmented separation plate for analyzing performance of MEA seen from a cathode, which plate is again mounted to a MEA wherein a long time operation is completed with a typical separation plate mounted thereto and is provided with individual flow paths. FIG. 2 is a schematic view showing the segmented separation plate, wherein the individual flow paths formed, seen from an anode.

First, the MEA is operated for a long time while a typical separation plate having an air inlet and an air outlet diagonally formed in the plate is mounted to the MEA. After the completion of the long time operation, a segmented separation plate 20 for measuring the performance of the MEA as shown in FIGS. 1 and 2 is mounted to the MEA. FIG. 1 shows that an air inlet and an air outlet are respectively formed in each area 23 segmented in a MEA corresponding to area 22 of the segmented separation plate 20. FIG. 2 shows that the fuel hydrogen inlet and hydrogen outlet are respectively formed in the segmented individual areas 23.

The segmented separation plate having the individual flow paths is manufactured, for example, as follows.

A conducting graphite block is used so as to form the segmented individual areas. Herein, six to eight areas are formed, each of which has an active area of about 3.3×3.3 cm². The graphite block has a flow path design having a general flow path form (for example, serpentine or straight form). A support 21 of insulating polymer such as polycarbonate, acryl, epoxy glass and the like is provided with holes, into which the graphite block having the flow path is respectively inserted, thereby providing the segmented individual areas 23. Herein, when a gasket is used in the segmented area, a contact resistance between the separation plate and the electrode is increased due to a thickness of the gasket. Accordingly, it is preferred to regulate the thickness of the gasket as small as possible so as to decrease the contact resistance. More preferably, the gasket is not used. Since there is a space between an edge of the MEA and the flow path in each segmented area, the air and the fuel hydrogen are not mixed even when the gasket is not used.

Meanwhile, a collector plate is mounted to a rear surface of the segmented separation plate. However, the current and voltage can be regulated in a manner of directly inserting a copper wire in each of the segmented areas without mounting the collector plate. That is, for example, it is possible to analyze the performance by measuring the current and voltage characteristics in each area of the MEA in a manner of inserting two copper wires into the segmented areas and then regulating the current and voltage with the wires.

The separation plate with or without the collector plate is provided with an end plate, so that a segmented cell for analyzing performance of MEA is completed.

Meanwhile, when manufacturing a segmented separation plate which will be mounted to the MEA after the long time operation, it is possible to form a separation plate structure and a flow path design by using a PCB, for example. That is, the separation plate structure and the flow path are manufactured with a PCB, a rib position contacting the MEA is coated with Cu and then Au is coated thereon, so that it is used as a collector plate. For an electrical short between the segmented areas, a rib bounded on the respective areas is not coated to expose the PCB. Thereby, the segmented area consists of plural rib pieces electrically shorted and wires passing through the PCB are drawn from each of the rib pieces, thereby sensing the current and voltage.

Hereinafter, a preferred example of the invention will be described to explain the invention more in detail. However, it should be noted that the invention is not limited to the following example and a variety of modification can be made. The following example is provided to fully disclose the invention and to allow a skilled in the art to easily carry out the invention.

### EXAMPLE

The MEA of 250 cm² was operated for a long time of 5,500 hours (dry H₂/air, 145 A, 35° C.) using a typical separation plate. After that, the MEA was again mounted to a segmented separation plate having individual flow paths, and the performance (i-V) and the electrochemical characteristics (impedance, cyclic voltammetry) in each segmented area were measured.

The performance is measured at air inlet, H₂ and air inlet middle, H₂ inlet, air outlet, H₂ and air outlet middle and H outlet.

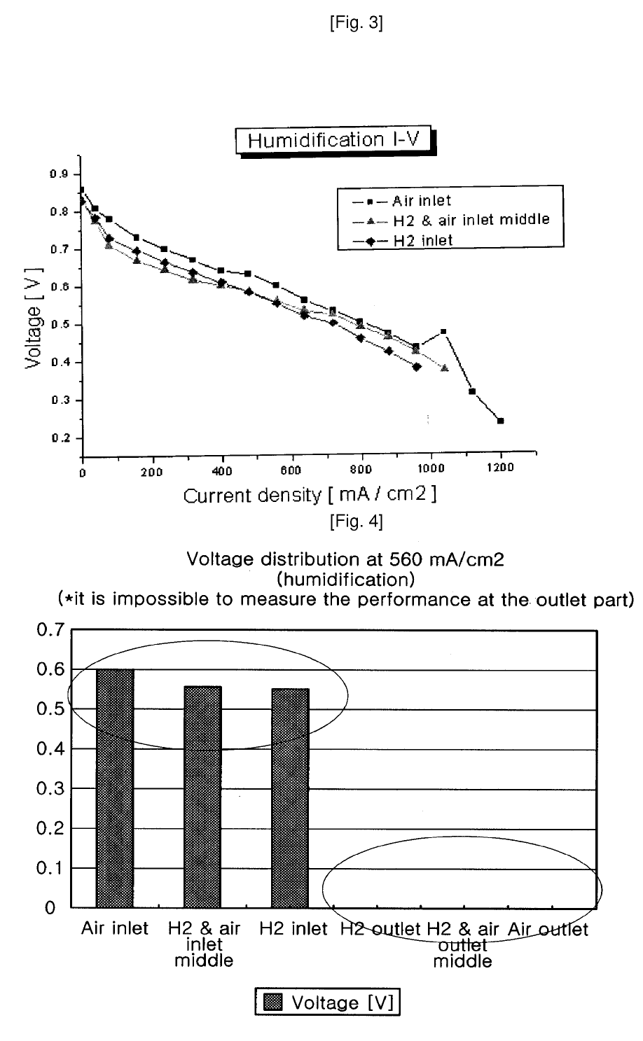

FIG. 3 is a graph showing i-V values of the MEA after the long time operation of 5,500 hours, which are measured using the segmented cell according to the example of the invention. FIG. 4 is a graph showing voltage distributions at each measurement part of the MEA in case of 560 mA/cm² of a specific current density after a long time operation of 5,500 hours, which are measured using the segmented cell according to the example of the invention. The performance at the air outlet, H and air outlet middle and H₂ outlet was not measured.

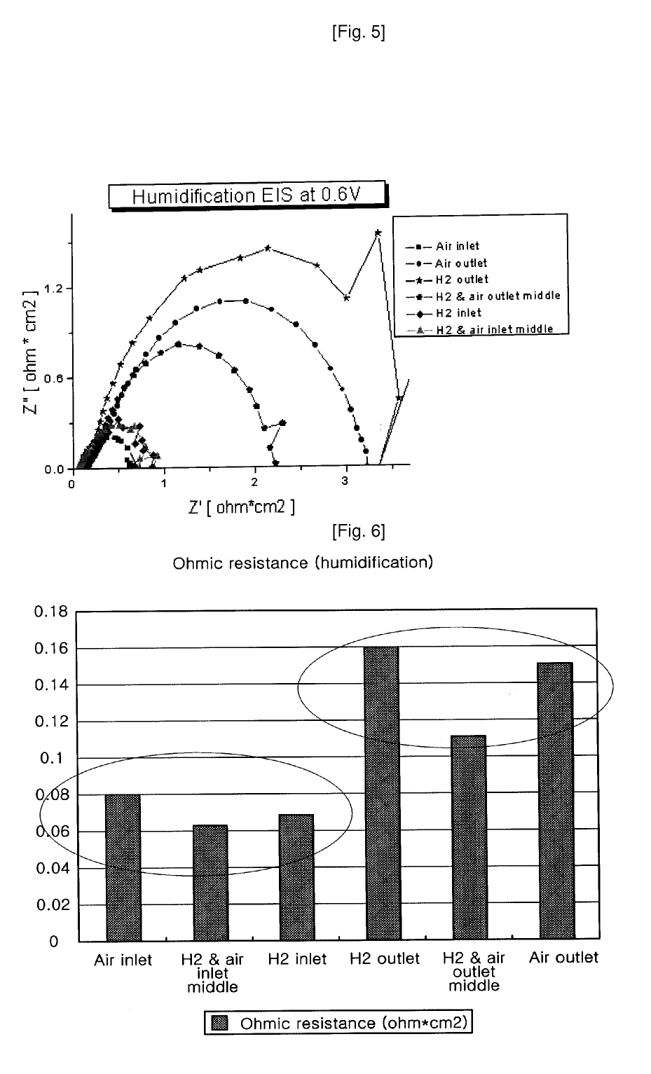

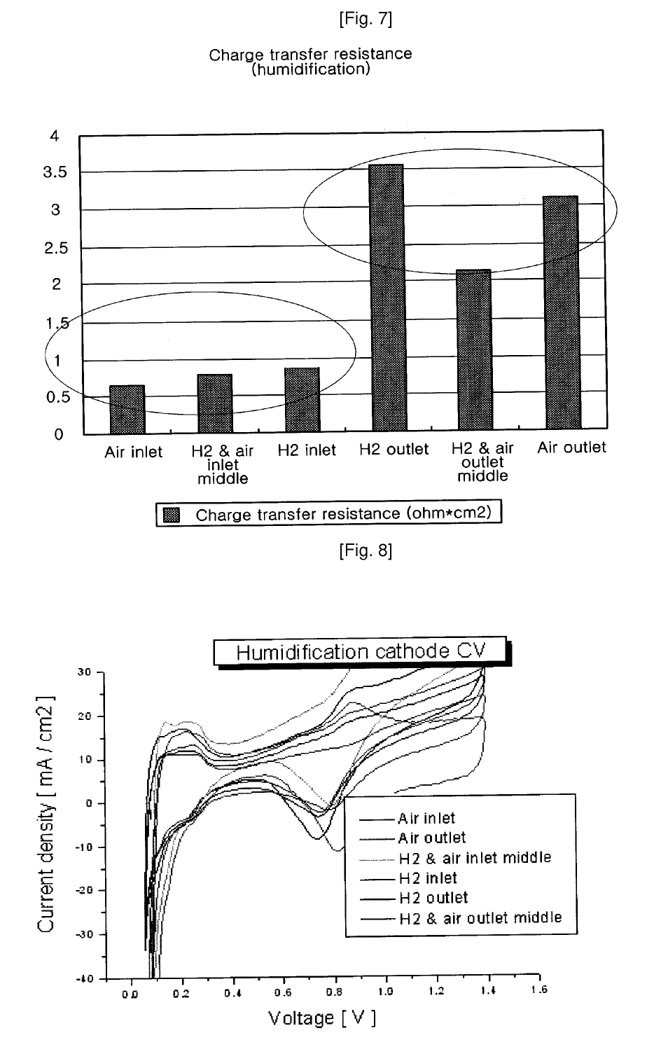

FIG. 5 is a Nyquist plot showing impedances of the MEA after the long time operation of 5,500 hours, which are measured using the segmented cell according to the example of the invention. FIG. 6 is the graph showing ohmic resistances in each measurement part of the MEA after the long time operation of 5,500 hours, which are measured using the segmented cell according to the example of the invention. FIG. 7 is a graph showing charge transfer resistances in each measurement part of the MEA after the long time operation of 5,500 hours, which are measured using the segmented cell according to the example of the invention.

As can be seen from FIGS. 5, 6 and 7, the resistance was higher at the outlet parts than the inlet parts.

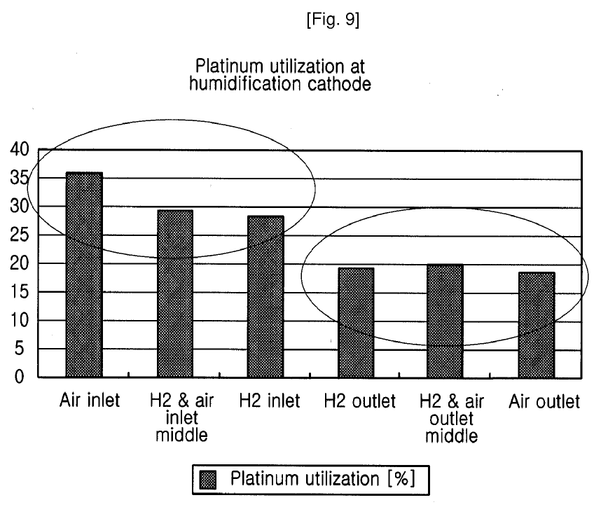

FIG. 8 is a cyclic voltammogram showing a cyclic voltammetry of the MEA after the long time operation of 5,500 hours, which is measured using the segmented cell according to the example of the invention. FIG. 9 is a graph showing platinum catalyst utilization at a humidification cathode in each part of the MEA after the long time operation of 5,500 hours, which are measured using the segmented cell according to the example of the invention.

As can be seen from FIGS. 8 and 9, the platinum catalyst utilization was lower at the outlet parts than the inlet parts.

As can be seen from the above, the performance was lower, ohmic resistance and charge transfer resistance was higher, the catalyst utilization was lower at the outlet parts, in which the gas was poor, than the inlet parts in which the gas was rich, after the long time operation of 5,500 hours.

That is, using the segmented cell of the invention, it was easily measured that the MEA was highly degraded at the outlet parts than the inlet parts. Further, it is possible to assess the non-uniformity of performance in the MEA which can occur according to the size increase of the MEA with the segmented cell of the invention.

### INDUSTRIAL APPLICABILITY

The invention relates to a method for analyzing performance of MEA and a segmented cell used for the method wherein a separation plate having a gas flow path formed is segmented without segmenting an electrode or a gas diffusion layer so that a deformation of a unit cell structure can be minimized and as well a degradation can be carried out as like that in a real MEA stack, thereby analyzing performance and electrochemical characteristics in each area of the degraded MEA.

1. A method for analyzing performance of MEA, wherein a separation plate having a gas flow path is segmented and mounted to MEA for analyzing performance of MEA, the method comprising steps of:
mounting a typical separation plate, which is not segmented, to a MEA and carrying out the operation of the MEA (S1); and
mounting the separation plate, which is segmented for analyzing performance of MEA, to the MEA in which the operation is completed and carrying out the analysis of the performance of the MEA (S2).

2. The method according to claim 1, wherein the gas flow path is formed in each of the segmented areas of the segmented separation plate used in the S2 step so that the gas can flow individually in each of the segmented areas of the segmented separation plate.

3. A segmented cell for analyzing performance of MEA, comprising a separation plate having a gas flow path, the separation plate being segmented for analyzing performance of MEA and the gas flow path being formed in each of the segmented areas of the segmented separation plate so that the gas can flow individually in each of the segmented areas of the segmented separation plate.

4. The cell according to claim 3, wherein the segmented cell is provided with a penetrating hole at a side of the segmented separation plate through which cooling water is able to be supplied.
